(19) United States
(12) Patent Application Publication
(10) Pub. No.: US 2026/0330292 A1
(43) Pub. Date: Oct. 22, 2026

(54) Machine Learning Scoring Models for Stratified Sample Selection

(71) Applicant: The Nielsen Company (US), LLC, New York, NY (US)

(72) Inventor: Hasan Coskun, Frederick, MD (US)

(21) Appl. No.: 19/181,918

(22) Filed: Apr. 17, 2025

(51) Int. Cl. G06N 20/00

(52) U.S. Cl. CPC G06N 20/00

(57) ABSTRACT

In one example, a method is described. The method includes training, by a computing system, a model based on a population estimate and a first set of demographic attributes of a subset of sample candidates to generate a trained model that determines a panelist score of a sample candidate for a panel. The panel represents a subset of a population determined by the population estimate. The panelist score indicates whether adding a sample candidate as a panelist would increase the representativeness of the panel. The method includes inputting into the trained model, the first set of demographic attributes of the subset and a second set of demographic attributes associated with a remainder of sample candidates into the trained model and outputting a panelist score for each of the sample candidates. The method includes selecting, based on the panelist score, a group to recruit to join the panel.

### TECHNICAL FIELD

The present disclosure generally relates to stratified sample selection for a panel of an audience measurement entity (“AME”) and, more particularly, to training and implementing a machine learning scoring model for the stratified sample selection.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect a method is described. The method includes training, by a computing system, a model based on a population estimate and a first set of demographic attributes of a subset of sample candidates to generate a trained model that determines a panelist score of a sample candidate for a panel of an audience measurement entity. The panel represents a subset of a population determined by the population estimate. The panelist score indicates whether adding a sample candidate as a panelist would increase the representativeness of the panel. The method also includes inputting, into the trained model, the first set of demographic attributes of the subset of the sample candidates and a second set of demographic attributes associated with a remainder of sample candidates from a sample pool into the trained model; outputting, from the trained model, a panelist score for each of the sample candidates for the panel of the audience measurement entity; and selecting, based on the panelist score, a group of sample candidates to recruit to join the panel for audience measurement. The method also includes determining, based on the panelist score, if a sample candidate of the sample candidates joins the panel of the audience measurement entity that the panel would be more representative of the population; and the selecting is further based on the determining. The demographic attributes of the subset of the sample candidates includes one or more of: age, race, gender, income, household size, number of children, education level, tenure on a panel, and location for each sample candidate of the subset of the sample candidates. The model is a tree-based model, and the model is trained using a gradient boosting algorithm. The method further includes: collecting measurement data of at least a portion of the group as panelists of the panel; and generating an audience metric using the collected measurement data of the panelists. The method further includes: determining a demand size, the demand size representing a number of panelists needed to fill the panel. The selecting further includes applying a weighted random sampling algorithm to select a number of the sample candidates to recruit to join the panel for audience measurement based on the demand size.

In another aspect, a non-transitory computer-readable storage medium, having stored thereon program instructions that, upon execution by a processor, cause performance of operations is described. The operations include obtaining sample pool data. The sample pool data includes a plurality of sample candidates and demographic attributes corresponding to each sample candidate of the plurality of sample candidates. The operations further include randomly selecting a subset of the plurality of sample candidates from the sample pool data and training, by a computer, a model based on a population estimate and a first set of demographic attributes of the subset of the plurality of sample candidates to generate a trained model that determines a panelist score of a sample candidate for a panel of an audience measurement entity. The panel represents a subset of a population determined by the population estimate. The panelist score indicates whether adding a sample candidate as a panelist would increase the representativeness of the panel. The operations further include inputting, into the trained model, the demographic attributes associated with each of the plurality of sample candidates into the trained model; outputting, from the trained model, a panelist score of each sample candidate of the plurality of sample candidates for the panel of the audience measurement entity; and selecting, based on the panelist score, at least a portion of the plurality of sample candidates to join the panel for audience measurement. The at least the portion of the plurality of sample candidates includes a first sample candidate and a second sample candidate. The operations further include enrolling, based on the selecting, a subset of the portion of the plurality of sample candidates as panelists. The operations also include collecting measurement data of the panelists. The operations also include that the selecting is based on a weighted random sampling algorithm. The demographic attributes of the plurality of sample candidates include one or more of: age, race, gender, income, household size, number of children, education level, and location. The model is trained using a gradient boosting algorithm. The model is a tree-based model.

In another aspect, a computing system is described. The computing system includes a processor and a non-transitory computer-readable storage medium, having stored thereon program instructions that, upon execution by the processor, cause performance of operations. The operations include training, by a computer, a model based on a population estimate and a first set of demographic attributes of a subset of sample candidates to generate a trained model that determines a panelist score of a sample candidate for a panel of an audience measurement entity. The panel represents a subset of a population determined by the population estimate. The panelist score indicates whether adding a sample candidate as a panelist would increase the representativeness of the panel. The operations further include inputting, into the trained model, the first set of demographic attributes of the subset of the sample candidates and a second set of demographic attributes associated with a remainder of sample candidates from a sample pool into the trained model; outputting, from the trained model, a panelist score of the each of the sample candidates for the panel of the audience measurement entity; and selecting, based on the panelist score, at least one sample candidate to recruit to join the panel for audience measurement. The model is a tree-based model. The model is trained using a gradient boosting algorithm. The operations also include determining, based on the panelist score, if a sample candidate joins the panel of the audience measurement entity that the panel would be more representative of the population; and the selecting is based on the determining. The operations further include enrolling, based on the selecting, the at least one sample candidate as a panelist; and collecting audience measurement data of the panelist.

### BRIEF DESCRIPTION OF THE DRAWINGS

FIG. 1 is a diagrammatic illustration of panel selection disclosed herein in accordance with one or more aspects.

FIG. 2 is a diagrammatic illustration of an example media exposure environment in communication with an example collections facility disclosed herein in accordance with one or more aspects.

FIG. 3 is a simplified block diagram of an example computing device in accordance with one or more aspects.

FIG. 4 is a simplified block diagram of an example system in accordance with one or more aspects.

FIG. 5 is a flow chart of an example method in accordance with one or more aspects.

FIG. 6 is a flow chart of an example method in accordance with one or more aspects.

### DETAILED DESCRIPTION

### I. Overview

An audience measurement entity (referred to herein as an “AME”) measures viewing trends of various demographics within a population. One way that the AME can measure the viewing trends is by developing a panel. The panel is a subset of the entire population that models the entire population. The panel models the entire population using stratified sampling. Stratified sampling partitions the entire population into subpopulations. These subpopulations can be based on one or more of the following categories: race, gender, age, number of children, language, education level, income level, location, household size, and the like. The AME determines a sample (also referred to herein as “a sample pool”), based on stratified sampling, that is representative of the population. The AME recruits the panelists based on the sample to form the panel. The AME recruits the panelists for a set period of time (e.g., two years, three years, or five years). The length of time allows the AME to conduct a longitudinal survey panel measuring the viewing trends of the same individuals over the set period of time.

One challenge of selecting a sample for the longitudinal survey panel is that people are supposed to stay in the panel for the set period of time. However, individuals can leave the panel early for various reasons such as the individuals no longer wanting to be panelists, or the individuals not complying with the requirements of the panel (e.g., do not indicate who is watching the television) and being asked by the AME to leave. Additionally, certain demographic groups leaving the panel before the end of the panel can be problematic. For example, if certain demographic groups are represented by a small number of participants within the panel and individuals from these demographic groups leave, those departures can alter the results of the panel in a statistically significant manner.

Several examples are described herein for advantageously developing a machine learning model to analyze the available sample candidates of the sample pool for selection into the panel. The machine learning model is trained based on a population estimate and a first set of demographic attributes of a plurality of sample candidates. The machine learning model is trained to determine a panelist score, which is indicative of whether adding a sample candidate as a panelist would increase the representativeness of the panel. The panel of the audience measurement entity represents a subset of a population determined by the population estimate. Once trained, the machine learning model can receive inputs of demographic attributes of the sample candidates and outputs the panelist scores for each of the sample candidates. The machine learning model can also determine based on the panelist score if one or more sample candidate(s) should be selected as a new panelist for the panel for audience measurement, as the panelist score is indicative of whether adding the new sample candidate would increase the representativeness of the panel.

Advantageously, the model can identify and prioritize sample candidates that best represent the diversity and the dynamics of the population, ensuring a more accurate and representative sample. Additionally, examples herein mitigate issues such as bias, underrepresentation, and scalability challenges, by directly addressing the inefficiencies of conventional stratified sampling methods. By dynamically adjusting scoring criteria, the model ensures sample candidates that more accurately reflect the current state of the population. The use of the model streamlines the sample selection process, which reduces the time, financial resources, and computational resources needed to identify suitable sample candidates. For example, the use of an optimization model and weighted random sampling algorithm, described herein, increases computational efficiency by enabling group selection of sample candidates, rather than iteratively selecting a single candidate and then rescoring the remainder of the sample candidates. The model’s ability to analyze vast datasets and continually adjust scoring criteria mitigates biases and underrepresentation in the sample selection. Another advantage is that the use of the model is scalable and capable of handling large, diverse populations.

The operations and systems, described herein, provide techniques for improving the robustness and accuracy of the panel to be more representative of the population by developing a dynamic model that determines sample candidates that reflect the current population. The dynamic model is a machine learning model that is continuously refined using evolving population data to output information about the sample. For example, the model can output panelist score(s) to determine how valuable each individual of the sample will be if they were to join the panel and/or an expected tenure estimate that estimates how long each individual of the sample will stay in the panel. Based on their panelist score and/or their expected tenure estimate, a subgroup of the sample can be recruited to join the panel.

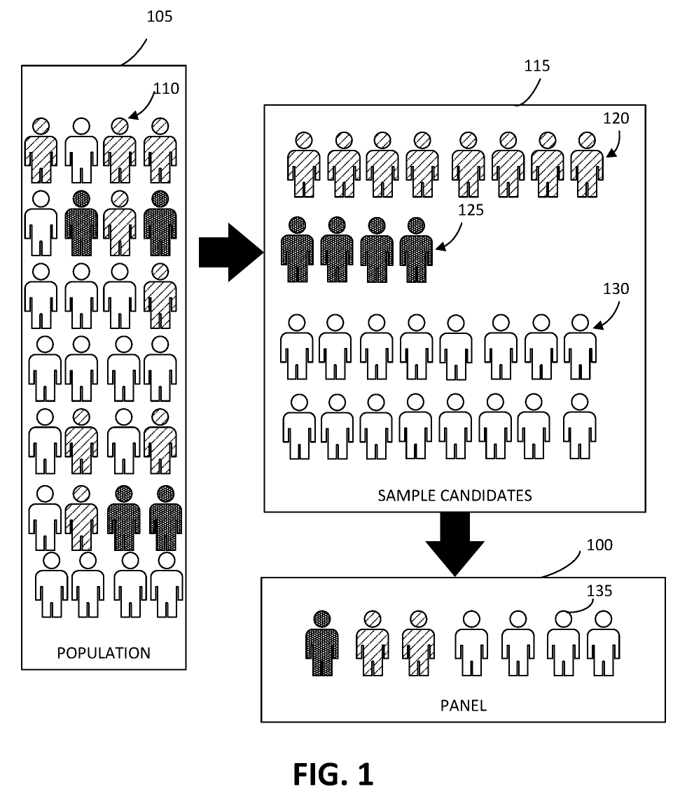

FIG. 1 is an illustration of an example panel selection using stratified sampling for a panel 100. The population 105 includes all of the individuals 110 within the population. The population can be a population of the United States, or a smaller population such as Atlanta, Georgia. The individuals 110 each have demographic attributes. The demographic attributes can include race, gender, age, ethnicity, household size, location, number of children, income, education level, job type, and the like. In stratified sampling, these demographic attributes of the individuals of the population can be broken into stratum, a subset of the population 105 that is being sampled. The stratum is also referred to herein as “sample candidates” 115. The sample candidates 115 include a first strata 120, a second strata 125, and a third strata 130. The first strata 120, the second strata 125, and the third strata 130 can each include a different number of individuals from the individuals 110, as shown in FIG. 1. The first strata 120 can represent a first demographic attribute, the second strata 125 can represent a second demographic attribute, and the third strata 130 can represent a third demographic attribute. From the sample candidates 115, the panel 100 is selected to be representative of the population 105. The panel includes panelists such as a panelist 135.

In some aspects, the population 105 includes households and their respective demographic attributes rather than the individuals 110.

In one or more aspects, more strata are included in the sample candidates 115. The first strata 120, the second strata 125, and the third strata 130 can represent a plurality of demographic attributes (e.g., Black, female, age 18-30 or Hispanic, Male). The first strata 120, the second strata 125, and the third strata 130 can also be broken down by a household type, the household type including one or more demographic attributes of member(s) of the household.

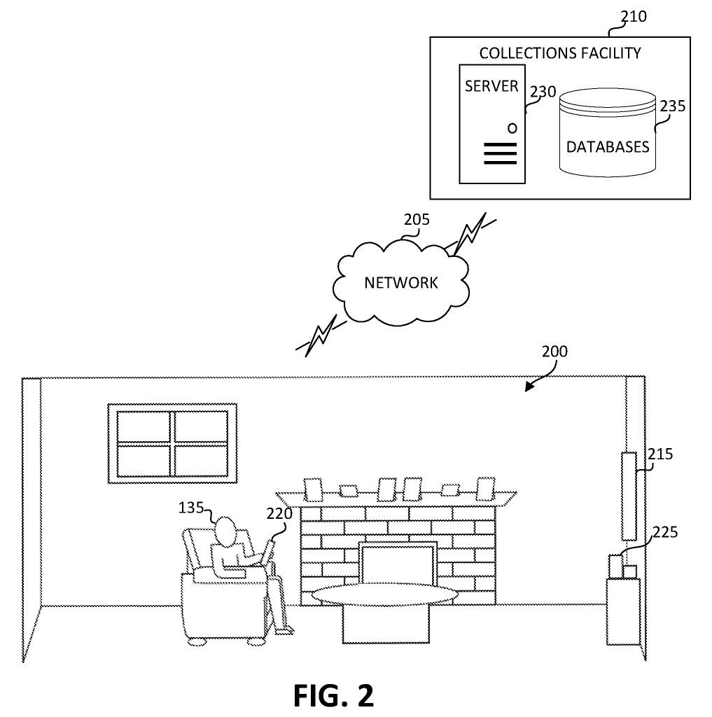

Once the panel 100 is selected, the AME monitors the panelists such as the panelist 135 using metering equipment to determine what is being watched, when, and by whom. For example, with reference to FIG. 2, FIG. 2 is an illustration of an example media exposure environment 200 in communication via network 205 with an example collections facility 210. The media exposure environment 200 includes a media device 215 and a portable media device 220. The media exposure environment 200 includes a meter 225 for collecting audience measurement data of one or more users in a household such as the panelist 135. The meter 225 is in communication with the collections facility 210 via the network 205. The collections facility 210 includes a server 230 and databases 235. The server 230 is in communication with the databases 235 for crediting media exposure. The collections facility 210 is remote from the media exposure environment 200 and is associated with the AME.

In the illustrated example of FIG. 2, the media exposure environment 200 is a room of a household (e.g., a room in a home of a panelist of an AME) that has been statistically selected to develop media ratings data for population(s)/demographic(s) of interest. In the illustrated example, the panelist 135 and/or the household of the panelist 135 has registered with the AME (e.g., by agreeing to be a panelist) and have provided demographic information to the AME to enable associating demographics with viewing activities (e.g., media exposure) for crediting media.

In one or more aspects, the media exposure environment 200 is a different room in the household than that illustrated by FIG. 2 such as a kitchen or a bedroom. The media exposure environment 200 can be a vehicle such as a car or airplane. The media exposure environment 200 can be in a room of a non-statistically selected home, a theater, a tavern, a retail location, an arena, or the like.

In some aspects, the network 205 can be a wired or wireless network. For example, the network 205 can be Bluetooth® network, the Internet, a cellular telephone network, an Ethernet network, any type of service provider network, any other type of wide area network, and/or any type of local area network.

In one or more aspects, the collections facility 210 is in communication with the media exposure environment 200 via the network 205. The collections facility 210 can include one or more servers (e.g., server 230, described herein) remote from the media exposure environment 200 that processes data from meters such as the meter 225.

In several aspects, the media device 215 and/or the portable media device 220 is an information presentation device. The information presentation can include a television, a radio, a video game console, a tablet, a laptop, a cellular device, a smartphone, a computer, a mobile device, and the like.

In some aspects, the media device 215 or the portable media device 220 is omitted.

The meter 225 can be a meter that communicates metering information about media consumption in the media exposure environment 200 to the collections facility 210. In at least one aspect, meter 225 is configured to collect and/or analyze data from audio and/or video signals (for example, audio and/or video signals from the media device 215) to be sent to the collections facility 210 for analysis and crediting. For example, the meter can detect watermarks in the audio signals from the media device 215 and/or generate signatures from the audio signals from the media device 215. Alternatively or additionally, the meter 225 can collect metadata to be sent to the collections facility 210. The meter 225, in some aspects, can be a wearable device or a portable meter such as a watch, necklace, headphones, or a device that can be clipped onto the clothes of the panelist 135 that collects and analyzes media viewed by the panelist 135. The meter 225, in other aspects, can be an application or a website on a media device such as the media device 215 for collecting and/or analyzing media viewed by the panelist 135. The meter 225, in some aspects, is coupled directly to the media device 215. In other aspects, a universal serial bus (USB) dongle is coupled to the media device 215, and the USB dongle wirelessly couples the media device 215 to the meter 225.

In some instances, the media exposure environment 200 further includes a streaming meter. In other instances, the meter 225 is replaced with a streaming meter. The streaming meter can take the form of a device, separate from a modem or router on a local area network of a monitored environment, that is coupled to the local area network (such as the network 205) and monitors network traffic to collect media exposure data for streaming media presented in the media exposure environment 200 by the media device 215 and/or the portable media device 220. The media device 215 and/or the portable media device 220 is a device that is connected to a home network (e.g., local area network such as the network 205) and configured to access streaming media via the Internet, such as by way of a streaming media application installed on that device, and configured to present the streaming media. In some instances, the streaming meter can be coupled to a router via a wired connection or a wireless connection. Alternatively, the streaming meter can be indirectly coupled to the router. For example, the streaming meter and the router can both be connected to the network 205. In other instances, the streaming meter can be a network device like a router that has been reprogrammed to perform streaming meter operations, a purpose-built computing device, the router and the streaming meter can be a singular device, or the like.

In some aspects, the server 230 can be a single server or a plurality of servers. The plurality of servers can be located in a plurality of locations remote from the media exposure environment 200. The server 230 can be a central processor system that is in communication with the databases 235. The server 230 can have a rules-based module to determine which database of the databases 235 to access.

In various aspects, the databases 235 can store information sent from the meter 225. The databases 235 can be a singular database or a plurality of databases. The databases 235 can store demographic information about the panelists such as the panelist 135 and media content information (such as signatures and watermark information) to identify media content. The database 235 can store demographic attributes about the panelists and/or information sent from the meter, which can be used by the server 230 to determine what media content was presented, who watched the media content, and what the demographics of the person who watched the media content. The server 230 can credit the media content as being presented to a particular demographic.

In operation, the panelist 135 fills out demographic information, which is stored by the AME, in a database of the databases 235 prior to the panelist 135 being selected as a panelist. The AME conducts stratified sampling to select the individual (the panelist 135) for inclusion in the panel, and the individual joins the panel as the panelist 135. The panelist 135 watches a program on the media device 215. The meter 225 determines media identification information (e.g., a watermark or a signature) using audio and/or video signals of the program. The meter 225 sends via the network 205 the media identification information to the collections facility 210. The media identification information is compared to reference information stored in the database 235. The server 230 credits the program as having been watched by a person with the demographics of the panelist.

Any one or more of the components described herein can take the form of a computing device, or a computing system that includes one or more computing devices.

### II. System Architecture

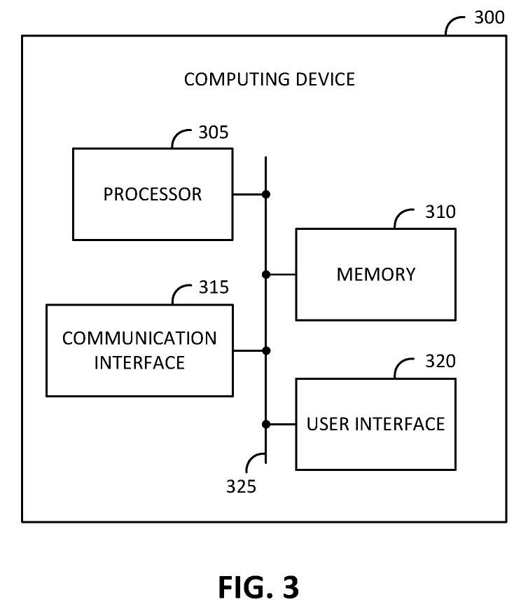

FIG. 3 is a simplified block diagram of an example computing device 300. The computing device 300 can be configured to perform one or more operations, such as the operations described in this disclosure. As shown, the computing device 300 can include various components, such as a processor 305, memory 310, a communication interface 315, and/or a user interface 320. These components can be connected to each other (or to another device, system, or other entity) via a connection mechanism 325.

The processor 305 can include one or more general-purpose processors and/or one or more special-purpose processors.

Memory 310 can include one or more volatile, non-volatile, removable, and/or non-removable storage components, such as magnetic, optical, or flash storage, and/or can be integrated in whole or in part with the processor 305. Further, memory 310 can take the form of a non-transitory computer-readable storage medium, having stored thereon computer-readable program instructions (e.g., compiled or non-compiled program logic and/or machine code) that, upon execution by the processor 305, cause the computing device 300 to perform one or more operations, such as those described in this disclosure. The program instructions can define and/or be part of a discrete software application. In some examples, the computing device 300 can execute the program instructions in response to receiving an input (e.g., via the communication interface 315 and/or the user interface 320). Memory 310 can also store other types of data, such as those types described in this disclosure. In some examples, memory 310 can be implemented using a single physical device, while in other examples, memory 310 can be implemented using two or more physical devices.

The communication interface 315 can include one or more wired interfaces (e.g., an Ethernet interface) or one or more wireless interfaces (e.g., a cellular interface, Wi-Fi interface, or Bluetooth® interface). Such interfaces allow the computing device 300 to connect with and/or communicate with another computing device over a computer network (e.g., a home Wi-Fi network, cloud network, or the Internet) and using one or more communication protocols. Any such connection can be a direct connection or an indirect connection, the latter being a connection that passes through and/or traverses one or more entities, such as a router, switcher, server, or other network device. Likewise, in this disclosure, a transmission of data from one computing device to another can be a direct transmission or an indirect transmission.

The user interface 320 can facilitate interaction between computing device 300 and a user of computing device 300, if applicable. As such, the user interface 320 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, the user interface 320 can include hardware and/or software components that facilitate interaction between the computing device 300 and the user of the computing device 300.

The connection mechanism 325 can be a cable, system bus, computer network connection, or other form of a wired or wireless connection between components of the computing device 300.

One or more of the components of the computing device 300 can be implemented using hardware (e.g., a digital signal processor (DSP), an application-specific integrated circuit (ASIC), a field-programmable gate array (FPGA), another programmable logic device, or discrete gate or transistor logic), software executed by one or more processors, firmware, or any combination thereof. Moreover, any two or more of the components of the computing device 300 can be combined into a single component, and the function described herein for a single component can be subdivided among multiple components.

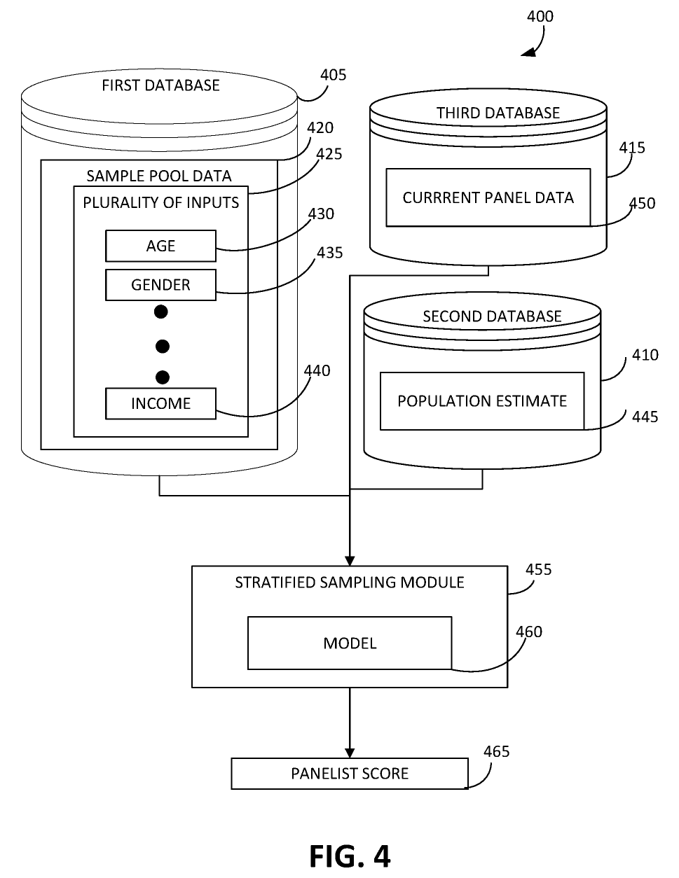

Referring to FIG. 4, with continuing reference to FIGS. 1-3, a simplified block diagram of an example system 400 is shown for stratified sample selection. The system 400 includes a first database 405, a second database 410, and a third database 415. The first database 405 includes sample pool data 420 of a plurality of sample candidates. The sample pool data 420 include a plurality of inputs 425 that correspond to one or more demographic attributes of the sample candidates. The plurality of inputs 425 includes, for example, age 430, gender 435, income 440, and other demographic attributes (not shown) of one or more of the sample candidates. The second database 410 includes population estimate 445. The third database 415 includes current panel data 450. The first database 405, the second database 410, and the third database 415 are each in communication with a stratified sampling module 455. The stratified sampling module 455 include a model 460. The model 460 is configured to analyze and to output a panelist score 465 for one or more sample candidates of the sample pool for selection into the panel, the panelist score 465 indicative of whether adding a sample candidate as a panelist would increase the representativeness of the panel.

In one or more instances, one or more components of the system 400 are implemented by the computing device 300 and/or the server 230 of the collections facility 210.

In some aspects, the first database 405, the second database 410, and/or the third database 415 can be combined into a single database.

In various instances, the first database 405 includes the sample pool data 420 of a plurality of sample candidates. The first database 405 can be a database of the databases 235 of the collections facility 210 associated with the AME.

In several aspects, the second database 410 includes the population estimate 445 or a plurality of population estimates, as described herein. The second database 410 can be a database of the databases 235 of the collections facility 210 associated with the AME. In other aspects, the second database 410 is remote from the collections facility 210 and is associated with a third-party who determines the population estimate 445.

In some aspects, the third database 415 includes the current panel data 450. The third database 415 can be a database of the databases 235 of the collections facility 210 associated with the AME.

In one or more instances, another database is included in the system 400. The other database includes historical inputs for previous sample candidates, previous panel members, and the like. The historical inputs can include the demographic attributes of previous panel members (e.g., education level, job type, number of children, and location), tenure information (e.g., three years, 3 months, and 4 years), panel information such as demand size, length of the panel, the panel composition over a period of time, a previous universe estimate, previous target demographic attributes, and other historical data. In other aspects, the historical inputs are stored in the first database 405, the second database 410, and/or the third database 415.

In various aspects, the sample pool data 420 includes data associated with sample pool candidates. The sample pool candidates can be the sample candidates 115, the persons of the population 105 being sampled. The sample pool candidates of the sample pool data 420 can be broken into a plurality of strata or household types. These household types can be based on the plurality of inputs associated with the demographic attributes of each sample candidate. For example, a household type could be a plurality of demographic attributes (e.g., female, rural Mid-West, 50-65 years old) or based on a single demographic attribute (e.g., male).

In some aspects, the plurality of inputs 425 includes all of the demographic attributes provided by a sample candidate of the sample pool. For example, the sample candidate could fill out survey information online, over the phone, or by mail about their demographic attributes, which corresponds to the plurality of inputs 425. In other aspects, the plurality of inputs 425 for the sample candidate can be obtained, at least in part, by a third-party via a third-party database. The plurality of inputs 425 can be a single input if only a single demographic attribute is known about the sample candidate, or the plurality of inputs 425 can be a plurality of inputs corresponding to the various demographic attributes of the sample candidate if known. The plurality of inputs 425 can be for a sample household relating to one or more sample candidates living in the same house, rather than a single sample candidate.

In one or more aspects, the plurality of inputs 425 includes a plurality of demographic attributes associated with a sample candidate of the sample pool data 420 such as, but not limited to age 430, gender 435, and income 440. A portion of the plurality of inputs 425 can be a range for one or more sample candidate(s). For example, the age 430 of the sample candidate can be between the range 18-30 years of age. In other instances, a portion of the plurality of inputs 425 is a specific value. For example, the age 430 can be set as 44 years old for a sample candidate. In several instances, the plurality of inputs 425 can include race, ethnicity, household size, number of children, education level, income level, job type, language spoken, location, market and/or the like. Additional input can be included in the plurality of inputs. In some instances, a portion of the plurality of inputs 425 are left blank and/or are unknown for the sample candidate.

In one or more aspects, the population estimate 445 can be population data. The population data can include a population estimate from a single source such as a proprietary universal population estimate. The population data, in other instances, can include population estimates from multiple sources such as a proprietary universal population estimate, a universe estimate, or based on census data, or the population estimate 445 represents a combination of population estimates from multiple sources (e.g., an average between census data and propriety universal population estimate). The population estimate 445 can be updated at a regular interval (e.g., yearly, every four years, or every ten years). The population estimate 445 can include a total number of the population (such as the population 105 in FIG. 1). The population estimate 445 can also include target demographic attribute proportions derived from the population data, where the target demographic attribute proportions correspond to estimates for each of the demographic attributes that correspond to the plurality of inputs 425.

In some aspects, in the third database 415, the current panel data 450 can include the current makeup of the panel of the AME. The current panel data 450 can include the demographic attributes of the panelists (such as, but not limited to: age, gender, income, education level, and the like), their panelist score, their tenure on the panel, their expected tenure score, their time left on the panel, and the like. The current panel data 450 can include a number of desired panelists and/or a number of panelists to fill the panel and the current number of panelists. The current panel data 450 can include demand or a forecasted demand (number of panelists needed to satisfy the number of desired panelists). For example, the panel can be designed to have 10,000 panelists, the current panel makeup could include 9,700 panelists due to some panelists leaving the panel early, therefore the current demand could be 300 additional panelists. However, in some instances, a forecasted demand can also be included. For example, in three months’ time, an additional 50 panelists are needed due to an expected retention rate. The current panel data 450 can include panelists data grouped by household rather than individual panelists, in some instances.

In several aspects, the stratified sampling module 455 is software programmed to score sample candidates on if it would benefit the panel to add this individual to the panel. The benefit of adding the sample candidate to the panel corresponds to determining if the demographic attributes of the sample candidate make the panel more representative of the entire population based on the population estimate 445. The software can be implemented using portions of the computing device 300. The stratified sampling module 455, in some aspects, can be implemented by server 230 of the collections facility 210.

In one or more aspects, the stratified sampling module 455 is further programmed to score the sample candidates on expected tenure. The expected tenure is the amount of time that the sample candidate is estimated to remain a panelist on the panel (e.g., 6 months, one year and two months, etc.). The expected tenure score can be determined using current panel data 450 and the plurality of input 425 of the sample candidates. For example, a particular demographic attribute of the panelists from the current panel data 450 can correlate to leaving the panel at a greater frequency (e.g., leave 15% earlier than the rest of the panelists), which can be used by a model to determine which sample candidates having that same demographic attribute in the sample pool data 420 can have an expected tenure rate that is 15% less than other sample candidates in the sample pool. In other aspects, a separate module includes an expected tenure model that is programmed to score the sample candidates on expected tenure.

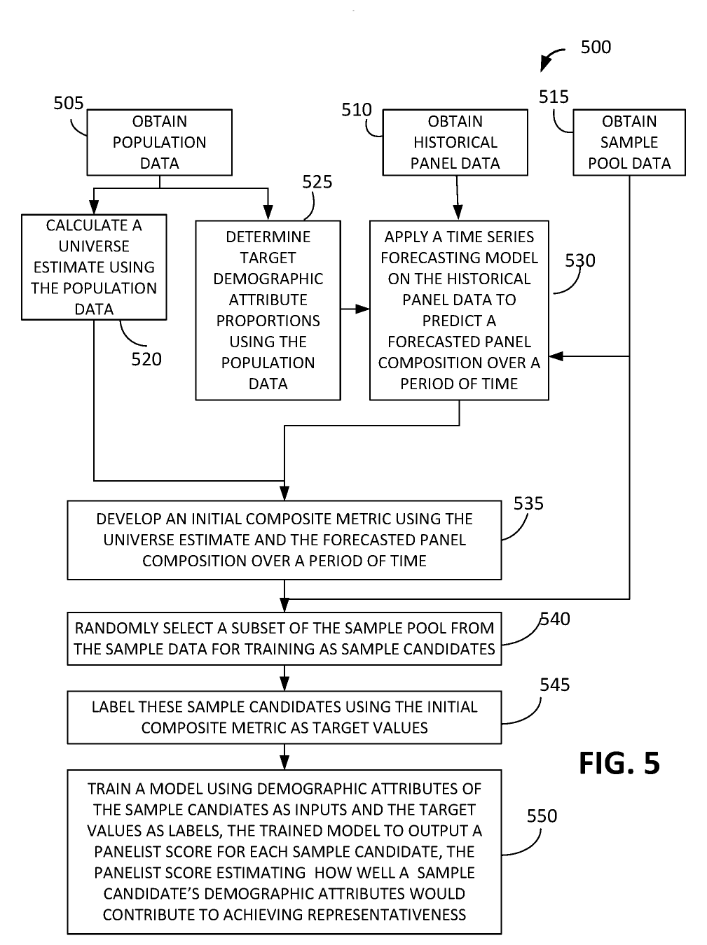

In some aspects, the model 460 of the stratified sampling module 455 is trained and/or retrained using the same data that is used to score at least a portion of sample candidate as a potential panelist using the panelist score 465. The data used to train the model 460 can include one or more of the following demographic attributes: age, race, ethnicity, gender, market, location, household size, number of children, language spoken, education level, income level, type of work, or the like. In some instances, a plurality of demographic attributes are used to train the model 460. Not all inputs or demographic attributes will be available for the subset of sample candidates used to train the model 460. The model 460 can also trained using the population estimate 445. The model 460 can be trained as described below in FIG. 5. The model 460 is a machine learning model. The model 460 is a tree-based model. In some instances, the tree-based model uses gradient boosting. Gradient boosting provides distinct pathways from the plurality of inputs 425 to the derived panelist score 465, using multiple decision trees. The model 460 can be trained using a gradient boosting algorithm. Reviewing the trained model 460 can determine the importance of each input of the plurality of inputs 425 in determining the panelist score 465. In other instances, another type of machine learning model is implemented instead of gradient boosting such as random forest.

In one or more aspects, the panelist score 465 is a value or number that indicates how valuable this sample candidate or sample household would be if they were to join the panel of the AME. The panelist score 465, in some instances, is a number from 1 to 100, from 1 to 1000, or from 1 to 10,000. The panelist score 465, in other instances, is a percentage, where 0% is not valuable and 100% is very valuable. The panelist score 465 can be for an individual or for a household.

In one or more aspects, the panelist score 465 is compared with panelist scores from other models for validation.

In some aspects, the model 460 can output an expected tenure of the panelist or an expected tenure score along with the panelist score. The expected tenure or the expected tenure score would indicate if the sample candidate would be likely to leave the panel before the set time of the panel is over, which could impact the accuracy of the longitudinal survey panel and increase resources for the panel (e.g., computer costs to determine a new panel member, and financial costs to onboard a new panel member).

### III. Example Operations

The computing device 300 and/or components thereof, such as the stratified sampling module 455, can be configured to perform and/or can perform one or more operations. Examples of these operations and related features will now be described.

With reference to FIG. 5 and continuing reference to FIGS. 1-4, a method 500 for training the model 460 of the stratified sampling module 455 of FIG. 4 according to one or more aspects. Method 500 is illustrated as a set of operations or blocks 505 through 550 and is described with continuing reference to FIG. 5. Not all of the illustrated blocks 505 through 550 can be performed in all aspects of method 500. One or more blocks that are not expressly illustrated in FIG. 5 can be included before, after, in between, or as part of the blocks 505 through 550. In some aspects, one or more of the blocks 505 through 550 can be implemented, at least in part, by the model 460 of the stratified sampling module 455 and/or the computing device 300, in the form of executable code stored on non-transitory, tangible, machine-readable media that when run by one or more processors can cause the one or more processors to perform one or more of the processes. FIG. 5 is a flow chart of an example method 500. Method 500 can be carried out by the computing device 300 and/or components thereof, such as the stratified sampling module 455. The method 500 includes obtaining population data at a block 505; obtaining historical panel data at a block 510; obtaining sample pool data at a block 515; calculating a universe estimate using the population data at a block 520; determining target demographic attribute proportions using the population data at a block 525; applying a time series forecasting model on the historical panel data to predict a forecasted panel composition over a period of time at a block 530; developing an initial composite metric using the universe estimate and the forecasted panel composition over a period of time at a block 535; randomly selecting a subset of the sample pool from the sample data for training as sample candidates at a block 540; labeling these sample candidates using the initial composite metric as target values at a block 545; and training a model using demographic attributes of the sample candidates as inputs and the target values as labels, the trained model to output a panelist score for each sample candidate, the panelist score estimating how well a sample candidate’s demographic attributes would contribute to achieving representativeness at a block 550.

In one or more aspects, the block 505 obtains population data from one or more databases. The databases can be the second database 410. The population data can be data relating to the population estimate 445. The population data can come from a plurality of sources such as, but not limited to: the U.S. Census Bureau, surveys, and state demographic centers. The population data can be transmitted from a database to a server of the AME such as the server 230. This population data can be received by the stratified sampling module 455 to train the model 460.

In some aspects, the block 510 obtains historical panel data from one or more databases at the block 510. The databases can be the additional database described in FIG. 4, the first database 405, the second database 410, and/or the third database 415. The historical panel data can be in a different database as the population data. In several aspects, the historical panel data is stored in the same database as the population data. The historical panel data can be transmitted from a database to a server of the AME such as the server 230. The historical panel data can include information about previous panelists of the AME and information about one or more previous panels, and/or information about current panelists of the AME (such as the current panel data 450) and information about the current panel(s). The previous panelists are individuals who previously agreed for a set period of time to have their media consumption monitored by the AME, and the monitoring by the AME ceased after the set period of time. The current panelists are individuals who previously agreed for a set period of time to have their media consumption monitored by the AME, and the set period of time is still occurring. The information about the previous and/or current panelists (“the panelists”) can include demographic attributes of each of the panelists such as the plurality of inputs 425. For example, the panelists or a representative of the AME could have filled out surveys for the panelists prior to (or while they were panelists). These surveys can include information such as age, gender, education level, income level, employment type, and the like. This information can be input into the database storing the historical panel data. In some instances, additional data can be called from third-party databases about the panelists. The amount of historical panel data associated with each of the panelists can be relative to the amount of information they provide in the survey, to the AME, and/or to a third-party. The historical panel data can include a panelist identifier (a name or an anonymous identifier for privacy), demographic attributes as described herein, retention data (how long did the panelist stay with the panel), and the like. The historical panel data can also include information about one or more panels such as number of panelists, demographic breakup of the panel, retention rate of the panel as a whole, and the like. This historical panel data can be received by the stratified sampling module 455 to train the model 460.

In one or more aspects, sample pool data is obtained from one or more databases at the block 515. The sample pool data can be the sample pool data 420 stored in the first database 405. The sample pool data, in the alternative, can be stored within another database. The sample pool data can be data corresponding to a sample pool or a subset of the population.

In some instances, the block 505, the block 510, and the block 515 occur concurrently. In other instances, the block 505 occurs, then the block 510, and then the block 515. In yet other instances, the block 510 occurs, then the block 505, and followed by the block 515.

In one or more instances, an additional block occurs after the block 505, the block 510, and/or the block 515 to validate the obtained data to verify consistency and accuracy. The validation can include an individual viewing the data for errors. The validation at the additional block can be automated with a set of rules. For example, the population data for a specific group is above X value and below Y value.

In various aspects, the block 520 occurs after the block 505. In some instances, the blocks 510 and the block 515 can occur before the block 520. In other instances, the block 520 occurs prior to the blocks 510 and 515. The block 520 includes calculating a universe estimate using the population data. The universe estimate can be the population estimate 445.

In one or more aspects, the block 525 occurs simultaneously to the block 520. In other aspects, the block 525 occurs after the block 520. The block 525 includes determining target demographic attribute proportions using the population data or strata proportions using the population data. For example, based on the population data, 20% of persons in the U.S. are Hispanic, the target demographic attribute, also referred to herein as strata, would be ethnicity: Hispanic, and the proportion would be 1 out of 5. The block 525 can determine a single target demographic attribute such as income level, 40-60K a year and the respective proportion based on the population data. The block 525 can also determine multiple target attributes such as Females, ages 20-29 years of age and their respective proportion based on the population data. In some aspects, the block 525 uses the calculated universe estimate as the population data. For example, the block 525 can determine the target demographic attribute proportions using the calculated universe estimate. The target demographic attribute proportions can also include target geographic proportions (such as, but not limited to: target rural proportion, target city proportion, region-based proportions such as the South, and the like).

In one or more aspects, the block 530 occurs after the block 520 and/or the block 535. The block 530 applies a time series forecasting model based on the historical panel data obtained in the block 510. The time series forecasting model primarily relies on historical panel data obtained from the block 510 to determine a demand size and/or the future panel composition. The historical panel data can include past panel compositions stored in the historical panel data. The time series forecasting model can predict a forecasted panel composition over a period of time. The period of time can be a number of weeks or a number of months ahead (such as, but not limited to, 3 months). The time series forecasting model can be implemented by a forecasting module (not shown) that is in communication with the stratified sampling module 455 and/or as part of the stratified sampling module 455.

In some instances, the block 530 and/or an additional block after the block 530 can determine demand size. The demand size can be estimated using outputs from the forecasting model described in the block 530, the current panel composition (such as from the current panel data 450), and the target demographic attribute proportions, using the population data from the block 525. The demand size can represent the number of panelists the AME needs to recruit (e.g., 500 panelists, 5000 panelists, or 50,000 panelists) to fill the panel. The demand size can be the initial demand (e.g., a total of 500 panelists) or can be a forecasted panel demand size (e.g., a total of 20 panelist are needed to replace panelists that are expected to drop out from the initial total of 500 after six months). The demand size can also include the forecasted panel composition needed to make the panel representative of the population estimate. The forecasted panel composition can include a panel composition with a plurality of demographic attributes based on the population.

In one or more aspects, the block 535 occurs after the block 530. The block 535 develops an initial composite metric using the universe estimate from the block 520 and the forecasted panel composition over a period of time from the block 530. The initial composite metric is a score that qualifies how well demographic attributes of a sample candidate would contribute to achieving representativeness (e.g., represent the population at large), given the past panel compositions obtained from the historical panel data and the target demographic distribution obtained in the block 525. In some instances, the initial composite score can be a “good fit” score that is used as a proxy for a sample candidate’s fit and can be used as a training label to train the model.

At the block 540, in various instances, a subset of the sample pool is randomly selected from the sample data obtained at the block 515 for training the model. The randomly selected subset of the sample pool can be a plurality of sample candidates. The block 540 occurs after the block 535.

The block 545 occurs after the block 540. In some instances, the block 545 labels each sample candidate using the initial composite metric as target values to train the model. The labeling can occur using the stratified sampling module 455.

The block 550 occurs after the block 545. In one or more instances, the block 550 includes training a model using demographic attributes of the sample candidates as inputs and the target values as labels. The model in the block 550 can be a machine learning model. The model can be the model 460. The model in the block 550 is trained to output a panelist score for each sample candidate. The panelist score can estimate how well a sample candidate’s demographic attributes would contribute to achieving representativeness. The panelist score can be the panelist score 465.

In one or more aspects, the method 500 also includes training an additional model to determine an expected tenure of the sample candidate and to output an expected tenure score. The model can be trained using the historical panel data (including the tenure of the previous panelists) along with corresponding demographic attributes to determine an expected tenure of the sample candidate based on their respective demographic attributes. The model can be implemented using the stratified sampling module 455. In some aspects, the expected tenure of the sample candidate output by the additional model changes and/or updates the panelist score 465. The panelist score 465 can account for both demographic attribute presentiveness and retention potential.

In some instances, the method 500 can be retrained upon each additional panelist entering and/or leaving the panel. The method 500, in several aspects, includes retraining the model when a new population estimate is determined, for example, when a new census is taken. In some instances, the model 460 is trained using a tree-based algorithm to form a tree-based model. The tree-based model can be further trained using a gradient boosting algorithm. Using a gradient boosting algorithm can be advantageous to determine which demographic attributes are weighted more heavily than other demographic attributes in determining the panelist score. Additionally and/or in the alternative, the gradient boosting algorithm can provide built-in metrics (such as, but not limited to: gain, frequency, and cover) that can reveal which demographic attributes most significantly impact the panelist score.

In various aspects, the method 500 can also include evaluating the model and tuning the model as part of training the model.

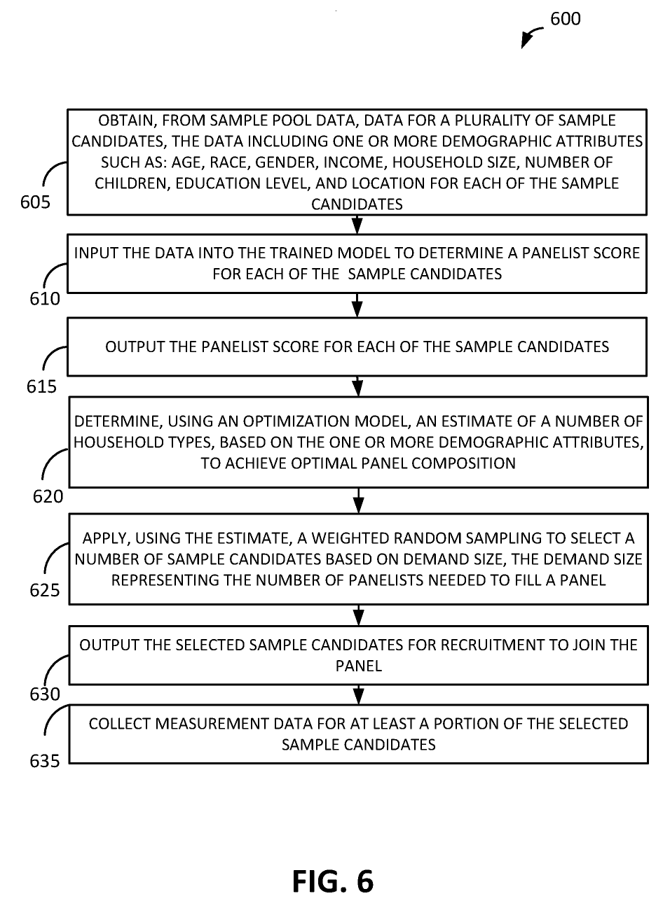

With reference to FIG. 6 and continuing reference to FIGS. 1-5, a method 600 for implementing the model 460 of the stratified sampling module 455 of FIG. 4 to determine a score of a new sample candidate, according to one or more aspects. Method 600 is illustrated as a set of operations or blocks 605 through 635 and is described with continuing reference to FIG. 6. Not all of the illustrated blocks 605 through 635 can be performed in all aspects of method 600. One or more blocks that are not expressly illustrated in FIG. 6 can be included before, after, in between, or as part of the blocks 605 through 635. In some aspects, one or more of the blocks 605 through 635 can be implemented, at least in part, by the model 460 of the stratified sampling module 455 and/or the computing device 300, in the form of executable code stored on non-transitory, tangible, machine-readable media that when run by one or more processors can cause the one or more processors to perform one or more of the processes. FIG. 6 is a flow chart of an example method 600. Method 600 can be carried out by the computing device 300 and/or components thereof, such as the stratified sampling module 455. The method 600 includes obtaining, from sample pool data, data for a plurality of sample candidates, the data including one or more demographic attributes such as: age, race, gender, income, household size, number of children, education level, and location for each of the sample candidates at a block 605; inputting the data into the trained model to determine a panelist score for each of the sample candidates at a block 610; outputting the panelist score for each of the sample candidates at a block 615; determining, using an optimization model, an estimate of a number of household types, based on one or more demographic attributes, to achieve an optimal panel composition at a block 620; applying, using the estimate, a weighted random sampling to select a number of sample candidates based on a demand size, the demand size representing the number of panelists needed to fill a panel at a block 625; outputting the selected sample candidates for recruitment to join the panel at a block 630; and collecting measurement data for at least a portion of the selected sample candidates at a block 635.

In some instances, the block 605 obtains the data from at least a portion of sample pool data from the sample pool data obtained in block 515. The sample pool data can include data for an entire sample pool (also referred to herein as all of the plurality of sample candidates) including the subset of the sample pool that was used to train the model, as described in FIG. 5. The sample pool data can be the sample pool data 420 of the first database 405. The sample pool data can include data for each of the plurality of sample candidates (such as the plurality of inputs 425). The data can include, but is not limited to the following demographic attributes: age, race, gender, income, household size, number of children, education level, ethnicity, and the like. The demographic attributes can also include geographic attributes of each of the plurality of sample candidates such as market area and location. The data for a first sample candidate can be different than the data for a second sample candidate. For example, the first sample candidate’s data can include age, race, and gender, but the second sample candidate’s data can include age, race, and number of children.

In various instances, a sample candidate of the plurality of sample candidate is an individual within a household. In other instances, a sample candidate of the plurality of sample candidates represents a household.

In some aspects, the data for all of the plurality of sample candidates (the entire sample pool) is input at the block 610. The data can include the portion of sample candidates from the sample pool used to train the model. In other aspects, data for a portion of the plurality of sample candidates (a portion of the sample pool) is input at the block 610. The trained model can be the model trained in FIG. 5.

In some aspects, at the block 615, the panelist score is output for each of the sample candidates. The block 615 can output the panelists scores for each of the sample candidates at the same time. The block 615 can output a group of panelist scores, including a first panelist score of a first sample candidate and a second panelist score of a second sample candidate. The panelist score can be the panelist score 465. The panelist score 465 can be output from the stratified sampling module 455 at the block 615. The model 460 of the stratified sampling module 455 can be configured to output the panelist score 465. The panelist score can be an integer value within a range (e.g., 0-100, 0-1000, and etc., a percentage value (e.g., 12%), or a single value (72)). The block 615 can output the panelists scores in the form of a report. The report can include a panelist identifier that was stored in the sample pool data along with their panelist score. In some aspects, the report can include one or more demographic attributes that contributed the most to the panelist scores. For example, demographic attribute A was weighted for the sample candidate A and increased sample candidate A’s panelist score by 12%. The report can include which sample candidates would be a good fit for a panel for audience measurement and which sample candidates would not make a good fit for the panel based on their respective panelists scores. The report can be output to a remote computing device, a mobile device, or application for display. The block 615 can also generate an alert when the report is generated. The report can include every panelist score of each sample candidate.

In some aspects, an additional block generates and outputs an expected tenure score for each of the sample candidates. The expected tenure score can represent the expected length of time the sample candidate would be on the panel before leaving or being asked to leave by the AME. The additional block can generate the expected tenure scores using a trained model, as described herein. The report can include both the panelist score 465 and the expected tenure score. For example, the report can indicate that the sample candidate has a high panelist score (e.g., 98) which indicates that the sample candidate would make the panel more representative of the population and has a low tenure score (e.g., 3 months). The report can state that due to the low tenure score, the sample candidate should not be selected as a panelist or that the sample candidate should be weighted less than a sample candidate with the same panelist score but a higher tenure score. The expected tenure score can be transmitted to a remote computing device, a mobile device, or an application for display. In some instances, the expected tenure score is factored into the panelist score and is output at the block 615.

In several aspects, the block 620 determines using an optimization model an estimate of a number of household types. These household types can correspond to the target demographic attribute proportions described in FIG. 5. The household types can be based on one or more of the demographic attributes of one or more sample candidates of a household. The household types can be predetermined by the AME. The household types, in other instances, is determined by a system such as the system 400 based on the current panel data 450 and the population estimate 445 to create groupings of household types that mirror the population estimate 445. The optimization model can be a separate model from the time series forecasting model described in FIG. 5 and a separate model from the model 460 described in FIG. 4. The optimization model can be a model in the stratified sampling module 455 or part of a separate module (such as a module within computing device 300). The optimization model can use the demand size (such as the demand size described in FIG. 4) or the number of panelists to be recruited including target demographic attribute proportions of the population estimate to determine a number of household types needed to create an optimized panel that is representative of the population estimate. The estimate determined by the optimization model can correspond to a desirable number of household types to achieve an optimal panel composition, such that the panel composition is representative of the population. The estimate output by the optimization model can be an optimized distribution. The estimate can be output by the stratified sampling module 455 or a separate module. In some instances, rather than household types, the optimization model provides an estimate of a number of panelists types, based on or more demographic attributes of a potential panelist.

In various instances, the block 625, an additional module of the computing device 300 or the stratified sampling module 455 applies a weighted random sampling algorithm. The weighted random sampling algorithm can select a desired number of sample candidates to be asked to join the panel for audience measurement using the estimate determined by the optimization model of the block 620. Sample candidates can then be selected through weighted random sampling based on the estimate to ensure that the total sample candidates selected equals the demand size and has an optimized distribution. Applying, using the estimate, the weighted random sampling to select the number of sample candidates based on the demand size can maintain randomness, while prioritizing higher-scoring candidates. The number of sample candidates to fill the panel can be based on demand size (such as the demand size described in FIG. 4). The demand size can be based on (1) the current composition of the panel and (2) the forecasted panel composition over a period of time. For example, if the panel is a 5,000-person panel, and there are 4200 persons currently on the panel, then there are 800 open spots to be filled. The demand size can include an additional percentage based on the average rate of rejection (+ 5%, +10% and the like). For example, if 800 invites for joining the panel are sent out to the selected sample candidates, and historically 10% of the invitees decline joining the panel, then the panel would still be short of its goal of having a 5000-person panel. The demand size can be based on the forecasted panel composition over a period of time by applying a time series forecasting model on the historical panel data and/or the current panel data to predict a forecasted panel composition over a period of time (such as 3 months or 6 months from now). The demand size can be based on making the panel representative with the population estimate (including the target demographic attribute proportions) through the use of the estimate provided by the optimization model. The weights of the weighted random sampling can be based on the panelist score (such as the panelist score 465) to weight the sample candidates with higher scores more than sample candidates with lower scores. Similarly, the weights of the weighted random sampling can be based on the panelist score, where the panelist score is based on the household.

One advantage of applying the weighted random sampling algorithm, using the estimate from the optimization model, is: rather than selecting the top one hundred sample candidates, who have the highest panelist score, using the weighted random sampling maintains randomness but prioritizes higher-scoring sample candidates. Another advantage of applying the weighted random sampling algorithm, using the estimate from the optimization model, is: improving computational efficiency by enabling group selection, rather than iteratively selecting a single sample candidate at a time and then rescoring the rest of the sample pool over again.

In some aspects, the block 630 occurs after the block 620, an additional module of the computing device 300 or the stratified sampling module 455 can output the selected sample candidates. The selected sample candidates are selected based on the weighted random sampling. The selected sample candidates can be the same number of panelists needed to join the panel (e.g., 3,000 selected sample candidates, for a 40,000-person panel that currently has 37,000 panelists). In other instances, the selected sample candidates can be a greater number of panelists needed to join the panel based on a historic rejection rate (e.g., 5,000 selected sample candidates, for a 40,000-person panel that currently has 37,000 panelists). The selected sample candidates can be output using their sample candidate identifier, name, address, or other identifying information in a report. The selected sample candidates can be output at the same time. The block 630 can output a group selection of sample candidates to increase computational efficiency, rather than selecting a single sample candidate, and then rescoring the remainder of the sample candidates.

In some instances, an additional block occurs after the block 630. The additional block can recruit the selected sample candidates to join the panel of the AME for a set period of time. The additional block can include sending a recruitment letter, email, or communication in response to the block 630, asking the selected sample candidate to join the panel of the AME for the set period of time. The additional block can also include enrolling at least a portion of the selected sample candidates as panelists and sending monitoring equipment and/or providing applications to collect media presentation data consumed by the selected sample candidate and/or her household.

In one or more aspects, the block 635 occurs after the block 630 after at least a portion of the selected sample candidates agree to be panelists for the panel for audience measurement. The block 635 can further include generating a rating or metric based on the audience measurement data collected for the panelist(s). The rating can include demographic attributes associated with the panelist(s) and/or the household type, as well as, media identifying information consumed by the panelist(s).

### IV. Example Variations

Although the examples and features described above have been described in connection with specific entities and specific operations, in some scenarios, there can be many instances of these entities and many instances of these operations being performed, perhaps contemporaneously or simultaneously, on a large-scale basis.

In addition, although some of the operations described in this disclosure have been described as being performed by a particular entity, the operations can be performed by any entity, such as the other entities described in this disclosure. Further, although the operations have been recited in a particular order and/or in connection with example temporal language, the operations need not be performed in the order recited and need not be performed in accordance with any particular temporal restrictions. However, in some instances, it can be desired to perform one or more of the operations in the order recited, in another order, and/or in a manner where at least some of the operations are performed contemporaneously/simultaneously. Likewise, in some instances, it can be desired to perform one or more of the operations in accordance with one more or the recited temporal restrictions or with other timing restrictions. Further, each of the described operations can be performed responsive to performance of one or more of the other described operations. Also, not all of the operations need to be performed to achieve one or more of the benefits provided by the disclosure, and therefore not all of the operations are required.

Although certain variations have been described in connection with one or more examples of this disclosure, these variations can also be applied to some or all of the other examples of this disclosure as well and therefore aspects of this disclosure can be combined and/or arranged in many ways. The examples described in this disclosure were selected at least in part because they help explain the practical application of the various described features.

Also, although select examples of this disclosure have been described, alterations and permutations of these examples will be apparent to those of ordinary skill in the art. Other changes, substitutions, and/or alterations are also possible without departing from the invention in its broader aspects as set forth in the following claims.

What is claimed is:

1. A method comprising:
training, by a computing system, a model based on a population estimate and a first set of demographic attributes of a subset of sample candidates to generate a trained model that determines a panelist score of a sample candidate for a panel of an audience measurement entity, the panel representing a subset of a population determined by the population estimate and the panelist score indicative of whether adding a sample candidate as a panelist would increase the representativeness of the panel;
inputting, into the trained model, the first set of demographic attributes of the subset of the sample candidates and a second set of demographic attributes associated with a remainder of sample candidates from a sample pool into the trained model;
outputting, from the trained model, a panelist score for each of the sample candidates for the panel of the audience measurement entity;
and
selecting, based on the panelist score, a group of sample candidates to recruit to join the panel for audience measurement.

2. The method of claim 1, further comprising:
determining, based on the panelist score, if a sample candidate of the sample candidates joins the panel of the audience measurement entity that the panel would be more representative of the population; and
wherein the selecting is further based on the determining.

3. The method of claim 1, wherein the first set of demographic attributes of the subset of sample candidates comprises at least one of: age, race, gender, income, household size, number of children, education level, tenure on a panel, or location for each sample candidate of the subset of the sample candidates.

4. The method of claim 1, wherein the model is a tree-based model, and wherein the model is trained using a gradient boosting algorithm.

5. The method of claim 1, further comprising:
collecting measurement data of at least a portion of the group as panelists of the panel; and
generating an audience metric using the collected measurement data of the panelists.

6. The method of claim 1, further comprising:
determining a demand size, wherein the demand size represents a number of panelists needed to fill the panel.

7. The method of claim 6, wherein the selecting further comprises:
applying a weighted random sampling algorithm to select a number of the sample candidates to recruit to join the panel for audience measurement based on the demand size.

8. A computing system comprising:
a processor; and
a non-transitory computer readable storage medium, having stored thereon program instructions that, upon execution by the processor, cause performance of a set of operations comprising:
training a model based on a population estimate and a first set of demographic attributes of a subset of sample candidates to generate a trained model that determines a panelist score of a sample candidate for a panel of an audience measurement entity, the panel representing a subset of a population determined by the population estimate and the panelist score indicative of whether adding a sample candidate as a panelist would increase the representativeness of the panel;
inputting, into the trained model, the first set of demographic attributes of the subset of the sample candidates and a second set of demographic attributes associated with a remainder of sample candidates from a sample pool into the trained model;
outputting, from the trained model, a panelist score for each of the sample candidates for the panel of the audience measurement entity;
and
selecting, based on the panelist score, at least one sample candidate to recruit to join the panel for audience measurement.

9. The computing system of claim 8, wherein the model is a tree-based model.

10. The computing system of claim 8, wherein the model is trained using a gradient boosting algorithm.

11. The computing system of claim 8, the set of operations further comprising:
determining, based on the panelist score, if a sample candidate joins the panel of the audience measurement entity that the panel would be more representative of the population; and
wherein the selecting is based on the determining.

12. The computing system of claim 8, the set of operations further comprising:
enrolling, based on the selecting, the at least one sample candidate as a panelist.

13. The computing system of claim 12, the set of operations further comprising:
collecting audience measurement data of the panelist.

14. A non-transitory computer-readable storage medium, having stored thereon program instructions that, upon execution by a processor, cause performance of a set of operations comprising:
obtaining sample pool data, wherein the sample pool data includes a plurality of sample candidates and demographic attributes corresponding to each sample candidate of the plurality of sample candidates;
randomly selecting a subset of the plurality of sample candidates from the sample pool data;
training a model based on a population estimate and a first set of demographic attributes of the subset of the plurality of sample candidates to generate a trained model that determines a panelist score of a sample candidate for a panel of an audience measurement entity, the panel representing a subset of a population determined by the population estimate and the panelist score indicative of whether adding a sample candidate as a panelist would increase the representativeness of the panel;
inputting, into the trained model, the demographic attributes associated with each of the plurality of sample candidates into the trained model;
outputting, from the trained model, a panelist score of each sample candidate of the plurality of sample candidates for the panel of the audience measurement entity;
and
selecting, based on the panelist score, at least a portion of the plurality of sample candidates to join the panel for audience measurement.

15. The non-transitory computer-readable storage medium of claim 14, wherein at least the portion of the plurality of sample candidates includes a first sample candidate and a second sample candidate, and wherein the first sample candidate and the second sample candidate are selected at a same time.

16. The non-transitory computer-readable storage medium of claim 14, the set of operations further comprising:
enrolling, based on the selecting, a subset of the portion of the plurality of sample candidates as panelists; and
collecting measurement data of the panelists.

17. The non-transitory computer-readable storage medium of claim 16, wherein the selecting is based on a weighted random sampling algorithm.

18. The non-transitory computer-readable storage medium of claim 16, wherein the demographic attributes of the plurality of sample candidates comprise at least one of: age, race, gender, income, household size, number of children, education level, or location.

19. The non-transitory computer-readable storage medium of claim 18, wherein the model is trained using a gradient boosting algorithm.

20. The non-transitory computer-readable storage medium of claim 19, wherein the model is a tree-based model.
